(19) United States
(12) Patent Application Publication
(10) Pub. No.: US 2007/0178871 A1
(43) Pub. Date: Aug. 2, 2007

(54) Communication system, converter for use therein and method of signalling

(75) Inventors: Christopher J. Cowdery, Cambridgeshire (GB); David J. Chapman, Cambridgeshire (GB); John Wood, Cambridgeshire (GB)

Correspondence Address: FOLEY AND LARDNER LLP;SUITE 500, 3000 K STREET NW, WASHINGTON, DC, 20007, US

(73) Assignee: New Transducers Limited

(21) Appl. No.: 10/551,407

(22) PCT Filed: Mar. 31, 2004
(86) PCT No.: PCT/GB04/01427

§ 371 Date: Aug. 14, 2006

(30) Foreign Application Priority Data
Apr. 2, 2003 (GB) 0307622.1

(51) Int. Cl. H04B 1/26

(52) U.S. Cl. 455/318; 455/333

(57) ABSTRACT

A communication system comprises first and second devices (2,3) having respective housings (5,6); a data trans-mission line (8) for transmitting data between the devices in a reflective signalling format; and conversion means (4) connectable to the line externally of the housings (5,6) for converting data between a reflective signalling format and another format. A method of signalling between first and second devices (2,3) linked by a transmission line (8) and of sensing a security violation of the line (8) comprises the steps of (a) transmitting a signal from the first device to the second device, reflecting the signal back to the first device in a manner corresponding to a first bit sequence, receiving the signal thus reflected at the first device, and comparing this signal with the transmitted signal to determine whether there has been a security violation of the line and to extract the first bit sequence.

### TECHNICAL FIELD

The present invention relates to communication between equipment, particularly electronic equipment, using the technique of reflective signalling.

### BACKGROUND TO THE INVENTION

The reflective signalling method of communicating between two or more pieces of equipment is described in detail in WO99/35780 (incorporated herein by reference). At its most basic level, the method involves the steps of (a) transmitting a signal from a first equipment to a second equipment; (b) reflecting said signal back to said first equipment in a manner corresponding to a first bit sequence; (c) receiving the signal thus reflected at said first equipment; and (d) comparing said signal thus reflected with said transmitted signal to thereby extract said first bit sequence. By using the signal reflection, a reduction in circuitry, complexity and energy consumption is possible relative to existing communication standards. In a preferred electronic embodiment, reflection of the signal in a manner according to a first bit sequence is achieved by modulating the impedance at the end of a transmission line connecting the equipment

In one particular arrangement, an infrastructure of transmission lines is used to communicate between a master node and a slave node, a router allowing the master to communicate with multiple slave nodes. In accordance with the principles outlined above, the slave node reflects the incident data back to the master, modulating the sense of the data by controlling the impedance at the end of the transmission line. The implementation of the slave node has the potential to offer a significant saving over the traditional implementation which requires a full transmitter system to return data to the master.

The present invention has as one objective the implementation of this new technology with existing equipment in a simple and convenient fashion. Another objective is to increase the security of this new technology.

### DISCLOSURE OF THE INVENTION

In a first aspect, the invention provides a communication system comprising: first and second pieces of equipment having respective housings; a data transmission line for transmitting data between said pieces of equipment in a reflective signalling format; and conversion means connected to said data transmission line externally of said respective housings for converting data between a reflective signalling format and another format suitable for processing by one of said pieces of equipment.

The conversion means located externally of the respective housings of the equipment enables that equipment to be converted to reflective signalling operation without interfering with the internal structure of the equipment itself.

In a second aspect, the invention provides a converter for converting data between a reflective signalling format and another format, said data being transferred between first and second pieces of equipment; wherein the converter is adapted to be located externally of said first and second pieces of equipment.

Again, a converter adapted to be located externally of the pieces of equipment to be connected, e.g. by provision of suitable electrical connectors for connection to the pieces of equipment and/or a suitable protective housing, allows that equipment to reap the benefits of communication using reflective signalling principles without incorporating reflective signalling technology into the equipment itself.

In both first and second aspects of the invention, the converter advantageously includes a signal connector for connection to one of the pieces of equipment and which may be releasable. Alternatively, the connector may form part of a connector assembly in which the converter is included. Where this connector assembly includes a housing, the converter may be located inside that housing, yielding a connector having no significant apparent increase in size over conventional connectors.

A further advantage of the reflective signalling concept described in the aforementioned WO99/35780 is the facility to transfer power as well as data along the same transmission line. An advantageous embodiment of the second aspect therefore envisages a converter that not only converts data but also power from one format to another.

A third aspect of the invention provides a method of signalling between first and second equipments linked by a transmission line and of sensing a security violation of said transmission line, the method comprising the steps of:
(a) transmitting a signal from said first equipment to said second equipment;
(b) reflecting said signal back to said first equipment in a manner corresponding to a first bit sequence;
(c) receiving the signal thus reflected at said first equipment; and
(d) comparing said signal thus reflected with said transmitted signal to determine whether there has been a security violation of said transmission line and to extract said first bit sequence.

Thus the reflection of signals is used not only to communicate between first and second equipments linked by a transmission line but also to sense any change in the characteristics of the transmission line that might indicate that security of the line has been compromised, e.g. that the structure of the line itself has been tampered with (‘tapping’) or some other—e.g. magnetic—method of extracting information from the line has been applied. Furthermore, such dual functionality is achieved with negligible increase in complexity. In a preferred embodiment, the reflected signal is compared with the transmitted signal to determine a round trip time. Successive round trip times may be monitored and an alarm signal generated when there is variation in successive round trip times indicative of a change in impedance somewhere along the transmission line resulting from a security violation. To detect any security violations that may only produce low level changes in impedance, the threshold at which reflected signals are considered received may be periodically lowered.

The invention also comprises a signalling system configured to operate in accordance with the third aspect and having means, e.g. an alarm light, for indicating when there has been a security violation of the transmission line or for shutting down the signalling system or for re-routing communication via a different transmission line. Such re-routing is known from the aforementioned WO99/35780.

### DESCRIPTION OF FIGURES

FIG. 1 is a block diagram of a communication system in accordance with the first and second aspects of the present invention;

FIG. 2 is a block circuit diagram of an electronic device adapted to operate in accordance with the third aspect of the present invention.

### BEST MODE OF THE INVENTION

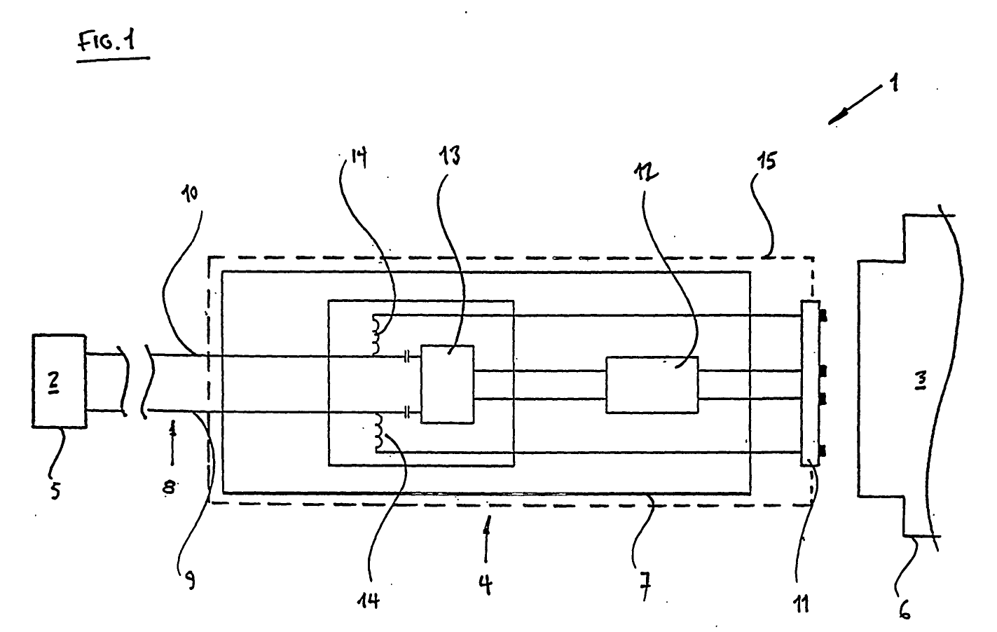

With reference to FIG. 1, a communication system 1 comprises first and second electronic devices 2,3 having respective housings 5,6 and, between the two, a converter 4 having a housing 7. Converter 4 and first device 2 are connected for reflective signalling via a transmission line 8 having two conductors 9,10 that may, for example, be arranged co-axially. Data received by converter 4 in reflective signalling format is fed to integrated circuit 13 which converts it to a conventional serial bitstream in the manner detailed in the aforementioned WO99/35780, an additional conversion module 12 allowing that bitstream to be converted into other formats such as analogue voltage in/out, RS485, parallel digital in/out. The reverse process takes place for return data. As explained in WO99/35780, line 8 can also transmit power and this is extracted as indicated at 14.

Arrangement of converter 4 externally of the devices 2,3 in accordance with the invention effectively permits retro-fitting of a reflective signalling system in place of a conventional system. This is facilitated by releasable signal connectors 11 as shown schematically between the converter 4 and second device 3 and which may also be arranged between line 8 and first device 2. Indeed, the compact nature of reflective signalling technology is such that the entire converter 4 may be integrated into the housing of the connector as indicated diagrammatically by means of dashed lines 15.

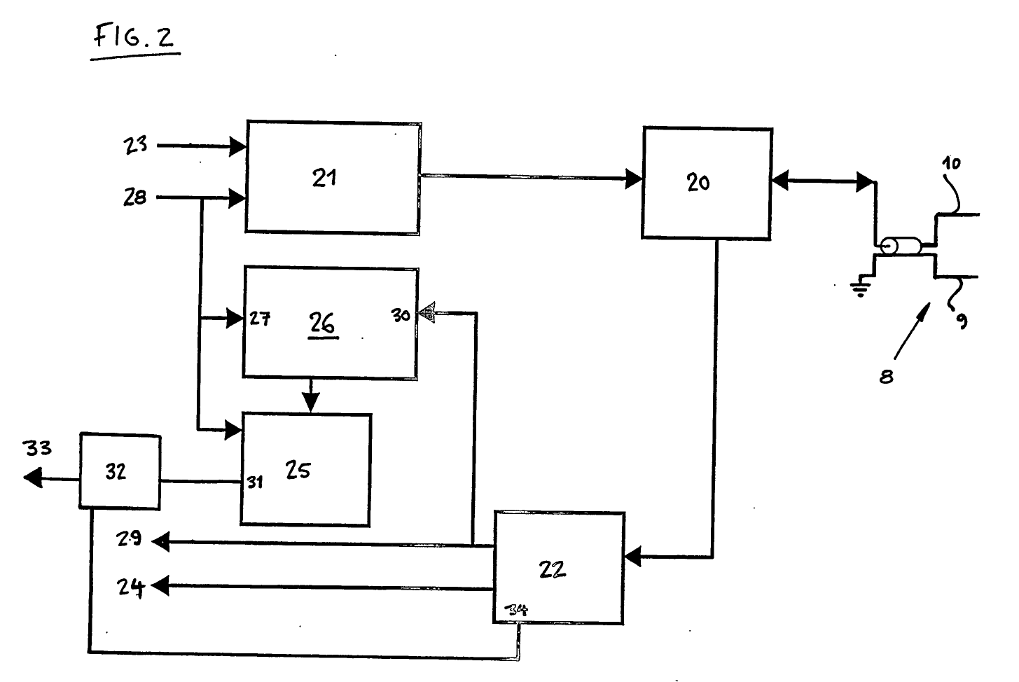

FIG. 2 is a block diagram of an embodiment of the third aspect of the present invention, those elements common with FIG. 1 being denoted by common reference figures.

Transmission line 8 comprising conductors 9 and 10 is connected via hybrid circuit 20 to transmission data waveshaper and receiver circuits 21,22 for transmitting data 23 and receiving data 24 as known from the aforementioned WO99/35780.

A counter 25 is also provided to measure the round trip time of a transmitted signal. The counter is cleared and enabled (via the S-R Latch 26 being set at 27) by transmission start signal 28. The counter then counts at a prescribed rate until the first reflected data bit of transmitted signal is received. This will generate a clock pulse 29 which will clear the S-R latch 26 (at 30) and hence stop the counter. The trip time value can then be read (at 31) to give a measure of the round trip time.

The present invention is based on the recognition that a security violation, i.e. tapping, at any point along the transmission line 8 will change the impedance of the line at the point of the violation and give rise to reflections having a shorter round trip time. Such a variation in round trip time is picked up by monitor 32 which in turn generates an alarm signal 33.

It will be appreciated that any change in impedance due to tapping is likely to be less than the change in impedance (open to short circuit) used for signalling proper. To pick up such lesser changes, receiver 22 may incorporate a variable receive threshold 34 that may also be operated on a periodic basis by monitor 32. Such a ariable threshold is known from WO99/35780.

1. Communication system comprising: first and second pieces of equipment having respective housings; a data transmission line for transmitting data between said pieces of equipment in a reflective signalling format; and conversion means connectable to said data transmission line externally of said respective housings for converting data between a reflective signalling format and another format suitable for processing by one of said pieces of equipment.

2. Communication system according to claim 1, wherein said conversion means includes a signal connector for connection to one of said pieces of equipment.

3. Communication system according to claim 1 and including a connector assembly including said conversion means and a signal connector for connection to one of said pieces of electrical equipment.

4. Communication system according to claim 3, wherein said connector assembly includes a housing, the converter being located inside that housing.

5. Communication system according to any one of claims 2 to 4, wherein said signal connector is releasable.

6. Communication system according to claim 1, wherein said conversion means also converts power between a reflective signalling format and another format suitable for consumption by one of said pieces of equipment.

7. Converter for converting data between a reflective signalling format and another format, said data being transferred between first and second pieces of equipment; wherein the converter is adapted to be located externally of said first and second pieces of equipment.

8. Converter according to claim 7 and including a signal connector for connection to one of said pieces of electrical equipment.

9. Converter according to claim 8, wherein said signal converter and said signal connector are located in a common housing.

10. Converter according to claim 8 or 9, wherein said signal connector is releasable.

11. Converter according to claim 7 and also adapted to convert power between a reflective signalling format and another format suitable for consumption by one of said pieces of equipment.

12. Method of signalling between first and second equipments linked by a transmission line and of sensing a security violation of said transmission line, the method comprising the steps of:
(a) transmitting a signal from said first equipment to said second equipment;
(b) reflecting said signal back to said first equipment in a manner corresponding to a first bit sequence;
(c) receiving the signal thus reflected at said first equipment; and
(d) comparing said signal thus reflected with said transmitted signal to determine whether there has been a security violation of said transmission line and to extract said first bit sequence.

13. Method of signalling according to claim 12 and comprising the step of comparing the signal thus reflected with the transmitted signal to determine a round trip time.

14. Method of signalling according to claim 13 and comprising the step of monitoring successive round trip times to determine any variation thereof.

15. Method of signalling according to claim 14 and further comprising the step of periodically lowering the threshold at which reflected signals are considered received.

16. Method of signalling according to any one of claims 12 to 15 and comprising the step of generating an alarm signal on determination of a security violation.

17. Method of signalling according to any one of claims 12 to 15 and comprising the step of blocking signalling between first and second equipments on determination of a security violation.

18. Method of signalling according to any one of claims 12 to 15 and comprising the step of re-routing signalling via a different transmission line on determination of a security violation.

19. Signalling system configured to operate in accordance with claim 16 and having means responsive to said alarm signal for visually indicating a security violation of the transmission line.

20. Signalling system configured to operate in accordance with claim 17 and having means for blocking signalling between said first and second equipments on determination of a security violation.

21. Signalling system configured to operate in accordance with claim 18 and having means for re-routing signalling via a different transmission line on determination of a security violation.
